(19) United States
(12) Patent Application Publication
(10) Pub. No.: US 2005/0039140 A1
(43) Pub. Date: Feb. 17, 2005

(54) Method to process multifunctional menu and human input system

(76) Inventor: Chien-Tsung Chen, Taipei (TW)

Correspondence Address: Ann Tsai;Suite 137, PmB 174, 931 West 75th Street, Naperville, IL, 60565, US

(21) Appl. No.: 10/797,098

(22) Filed: Mar. 11, 2004

(30) Foreign Application Priority Data
Aug. 14, 2003 (TW) 092122314

(51) Int. Cl. G09G 5/00

(52) U.S. Cl. 715/810; 715/808; 715/785; 715/809; 715/764; 715/781; 715/779; 715/840; 715/846; 715/835; 715/836; 715/837

(57) ABSTRACT

The processing method to deal with a multifunctional menu of a human input device is applied on a window operating system having plural window application programs. The menu operated on a human input device includes an auto-scroll menu to indicate scrolling function and a multifunctional menu so as to operate plural window application programs in a human interface mode. The multifunctional menu includes macro instruction icons, instruction icons corresponding to the macro instruction icons and a first switching icon for switching to the auto-scroll menu. The auto-scroll menu includes a second switching icon used on the auto-scroll menu for switching to the multifunctional menu.

### FIELD OF THE INVENTION

The present invention is related to a multifunctional menu used for a mouse or a keyboard, and especially to a multifunctional menu with a single operation and simple and tidy display frame, a human interface is provided by means of the multifunctional menu of the present invention, the multifunctional menu with multiple layers is joined to a single display frame with single operation by way of operating such a human interface, thereby a display frame with multiple level can be avoided to offer a user an environment of single operation and a simple and tidy display frame.

### BRIEF DESCRIPTION OF RELATED ART

Conventional multifunctional menus used for mice or keyboards are all menus; each menu displays only one layer in a popup mode with one operation step, a next layer is popped up after the former layer has been selected, thereby there are multiple layers popped up one by one in a frame of a display, so that a user must do multiple steps of operation in a complicated frame. Such a conventional operation mode of human interfaces has its convenience, but frequent use of a mouse or a keyboard is required to complete a functional selection on the last layer of menu; patience must be paid for temporarily suffering the confusing situation of popup displaying. This directly affects the feeling of comfort of a user in using a computer, and thereby this is a main defect of such a conventional human interface.

And more, conventional multifunctional menu always is provided by driver program given by mouse or keyboard provider; when a user installs a driver program given by the mouse or keyboard provider, the functions of the functional menu provided before installing the driver program are lost after installing; for example, during execution of an Internet Explorer provided by the Microsoft company, pressing down the middle key of a mouse will show an icon of auto-scroll to provide the function of scrolling by moving the mouse, such a human interface with the original function of automatic scrolling will be lost by installing the driver program.

In view of the above defects to be solved pressingly of the prior art, the inventor of the present invention provides a multifunctional menu that needs only one step for operation and has a simple and tidy display frame, and that includes the original function of automatic scrolling.

### SUMMARY OF THE INVENTION

The main object of the present invention is to provide a processing method to deal with a multifunctional menu of a human input device, it is applied on a window operating system having a plurality of window application programs. The present invention comprises the following steps:
A. To provide a menu operated on a human input device, wherein the menu includes: an auto-scroll menu for indicating the function of scrolling, and a multifunctional menu for operating a plurality of window application programs in a human interface mode; wherein the multifunctional menu includes a plurality of macro instruction icons corresponding respectively to a plurality of instruction icons of the macro instruction icons, and includes a first switching icon used on the multifunctional menu for switching to the auto-scroll menu, the auto-scroll menu includes a second switching icon used on the auto-scroll menu for switching to the multifunctional menu.
B. To receive at least one pressing signal induced by at least one predetermined key of the human input device.
C. To display the menu in a popup mode according to the pressing signals of the step B.
D. To receive the input signals of icons selected on the menu by the human input device.
E. To execute the commands in correspondence with the input signals of the icons of the step D.
   Wherein, the macro instruction icons are human operating interfaces to join said multifunctional menu with multiple layers as a single display frame instead of multiple layers of display frames so as to offer a user an environment of single operation and a simple and tidy display frame.

And more, to get the abovementioned object, the present invention provides a human input system applied on a window operating system having a plurality of window application programs. The human input system of the present invention comprises: a human input device used for executing the window application programs to provide at least one pressing signal induced by at least one predetermined key; a menu operated on the human input device, wherein the menu includes: an auto-scroll menu for indicating the function of scrolling; a multifunctional menu used for operating a plurality of window application programs in a human interface mode, wherein the multifunctional menu includes a plurality of macro instruction icons, the macro instruction icons respectively correspond to a plurality of instruction icons of the macro instruction icons; a first switching icon used on the multifunctional menu for switching to the auto-scroll menu, the auto-scroll menu includes a second switching icon used on the auto-scroll menu for switching to the multifunctional menu; program codes used in the human input device and used in execution of the window operating system: to receive the pressing signal induced by the predetermined key of the human input device to display the menu in a popup mode according to the pressing signals, to receive the input signals of icons selected on the menu by the human input device and to execute the commands in correspondence with the input signals of the icons.

The present invention will be apparent in its objects, features and functions for those skilled in this art after reading the detailed description of the preferred embodiment thereof in reference to the accompanying drawings.

### BRIEF DESCRIPTION OF THE DRAWINGS

FIG. 1 is a schematic perspective view of a computer hardware environment using the method of the present invention;

FIG. 2 is a flow chart of the method of the present invention;

FIG. 3 is a schematic view showing the icons respectively of an auto-scroll menu and a multifunctional menu;

FIGS. 4A-4D show the examples of the multifunctional menu of a plurality of macro instruction icons and a plurality of instruction icons respectively corresponding to the macro instruction icons; and

FIG. 5 is a schematic view of the construction of the human input system used for the method of the present invention.

### DETAILED DESCRIPTION OF THE INVENTION

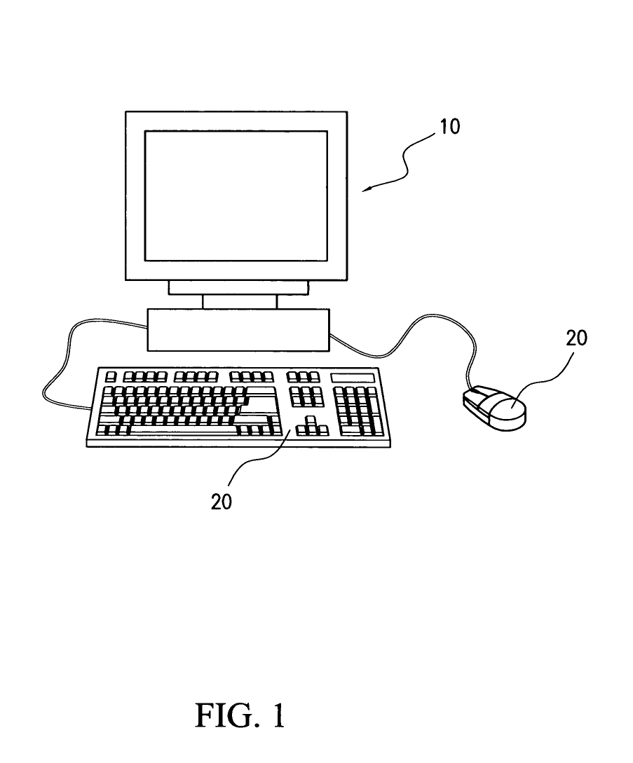

FIG. 1 is a schematic perspective view showing a computer hardware environment using the method of the present invention, the method 30 to deal with a multifunctional menu of a human input device is provided mainly for use of a computer 10, the computer 10 practically can be a desktop computer, a notebook, a tablet PC or one of other data processing electronic machines having CPU's. Execution of the computer 10 after turning on provides a user with a window operation platform, on this platform, a plurality of window application programs can be in operation by operating a human input device 20. The human input device 20 in practice can be a cable mouse, a wireless mouse, a cable keyboard, a wireless keyboard, a joy stick, a trackball, a touch pad, a cursor input device etc.

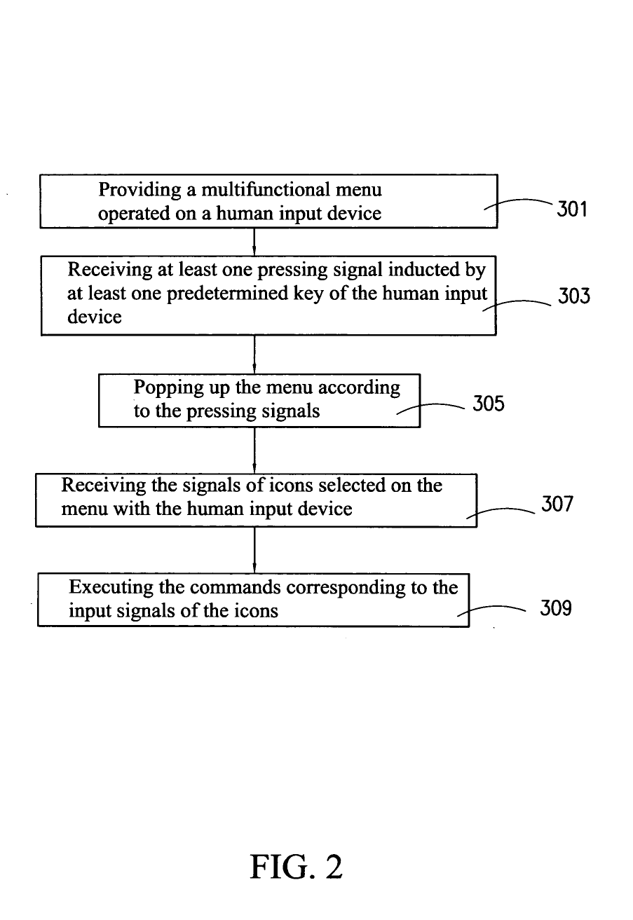

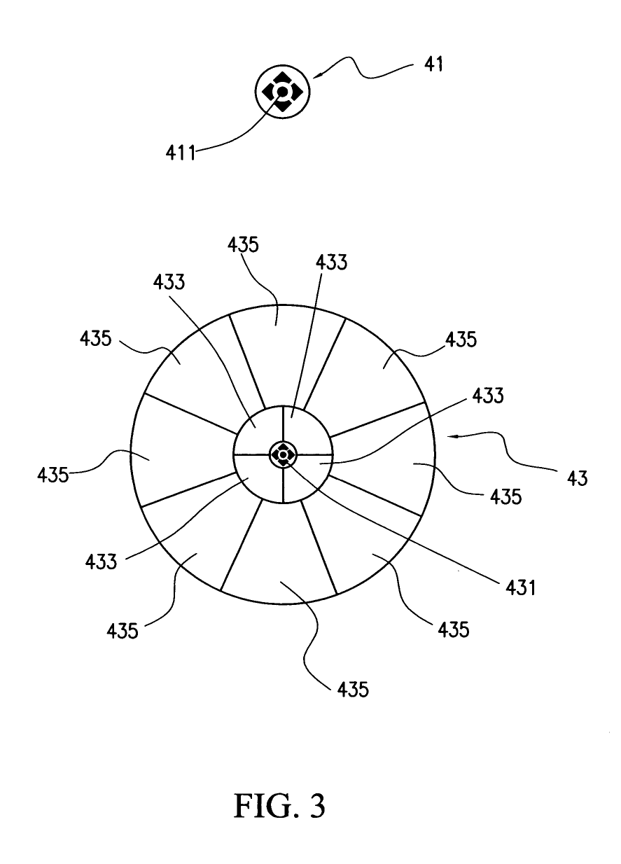

FIG. 2 is a flow chart of the method of the present invention, the method 30 to deal with a multifunctional menu of a human input device of the present invention mainly comprises the following steps. A step 301 is to provide a menu 40 operated on the human input device 20, wherein the menu 40 includes an auto-scroll menu 41 and a multifunctional menu 43. Please refer also to FIG. 3 which is a schematic view showing the icons respectively of the auto-scroll menu 41 and the multifunctional menu 43. The auto-scroll menu 41 of the present invention mainly is used to provide the functions of horizontal scrolling and vertical scrolling for displaying frames of a display. When the computer 10 pops out the icon of the auto-scroll menu 41, the user can execute the function of scrolling with the human input device 20. For example, the user moves a mouse up and down to execute the function of vertical scrolling, and moves the mouse left and right to execute the function of horizontal scrolling or the user presses the upward arrow key or the downward arrow key on a keyboard to execute the function of vertical scrolling, and presses the leftward arrow key or the rightward arrow key on the keyboard to execute the function of horizontal scrolling. Further, when the user clicks with the mouse to select a second switching icon 411 used on the auto-scroll menu 41, at this time, the computer 10 shuts the icon of the auto-scroll menu 41 and immediately displays in a popup mode the icon of the multifunctional menu 43. Similarly, the user clicks with the mouse to select a first switching icon 431 used on the multifunctional menu 43, the computer 10 shuts the icon of the multifunctional menu 43 and immediately displays in the popup mode the icon of the auto-scroll menu 41; in this way, the user can extremely conveniently switch between the menus 41 and 43.

A step 303 is to receive at least one pressing signal induced by at least one predetermined key of the human input device 20 and a step 305 is to display the menu 40 in a popup mode according to the pressing signals of the step 303. The principal object of the steps 303 and 305 are used to provide the user with technical means so as to make the computer 10 pops out the menu 40. In particular practice of steps 303 and 305, for example, the present invention can be used to receive the pressing signals of the middle key of the mouse or to receive the pressing signals of an F1 key or more than one key including F1, F2 of the keyboard. Certainly the present invention is not limited to the pressing signals of the middle key or the pressing signals of the F1 key or more than one key including F1, F2. The above mentioned predetermined key can be one of the middle key, the third key, the fourth key, the fifth key or a further added key (a key added subsequent to the sixth key) of the mouse. Also, the aforesaid predetermined key can be one key or one of a group of keys of the keyboard.

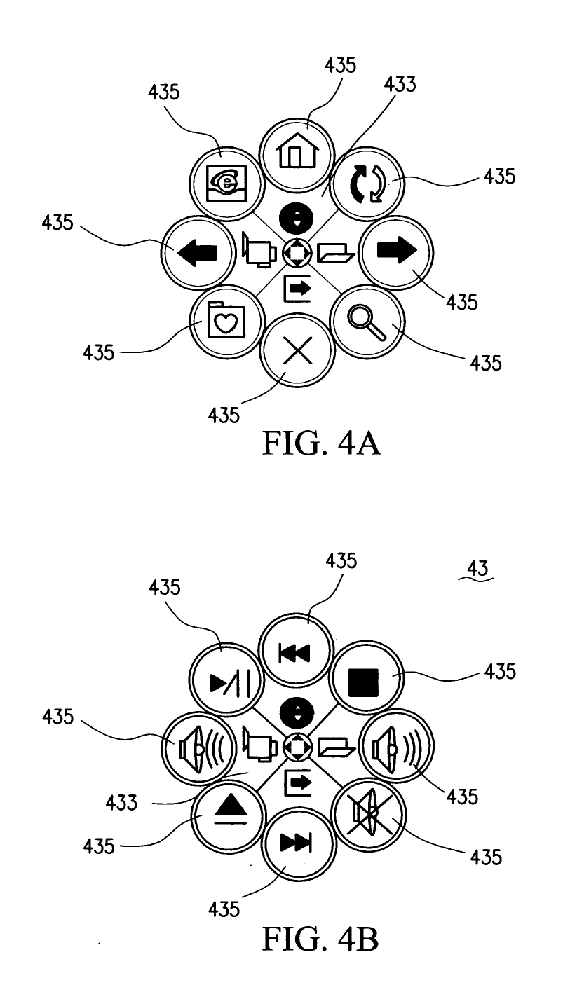

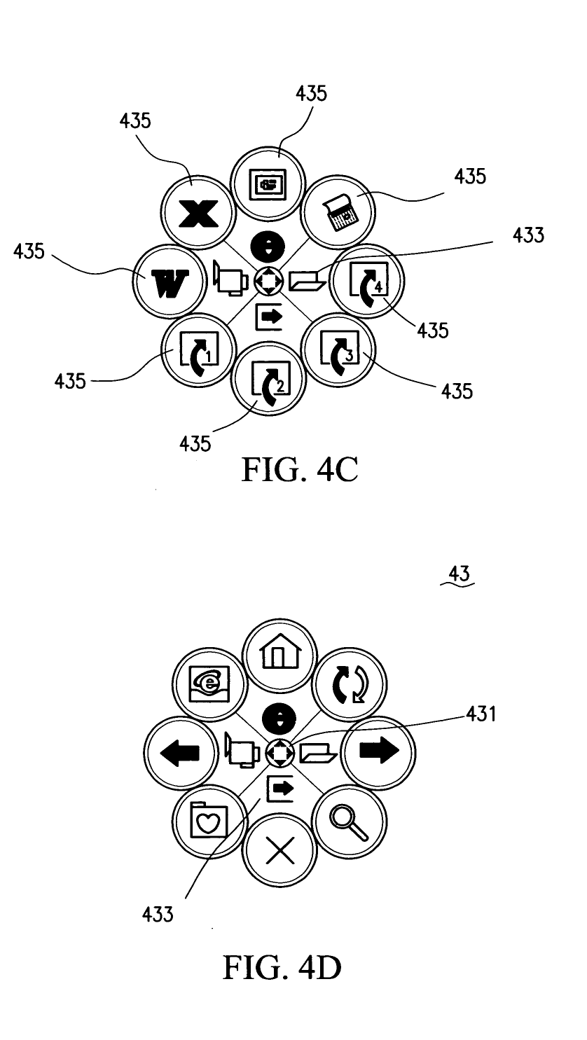

By virtue that the multifunctional menu 43 of the present invention includes a plurality of macro instruction icons 433 and a plurality of instruction icons 435 corresponding respectively to the macro instruction icons 433, the user can select respective icons by means of the human input device 20 from the multifunctional menu 43 displayed in the popup mode. Please refer to the examples shown in FIGS. 4A-4D, the examples of the multifunctional menu 43 of the macro instruction icons 433 and the instruction icons 435 respectively correspond to the macro instruction icons 433. The multifunctional menu 43 in FIG. 4A is used to express the state of the macro instruction icons 433 being on the multifunctional menu 43 and being selected by the user and representing network related applications of the icons 435. The multifunctional menu 43 in FIG. 4B is used to express the state of the macro instruction icons 433 being on the multifunctional menu 43 and being selected by the user and representing multimedia related applications of the icons 435. The multifunctional menu 43 in FIG. 4C is used to express the state of the macro instruction icons 433 being on the multifunctional menu 43 and being selected by the user and representing office related applications of the icons 435. The multifunctional menu 43 in FIG. 4D is used to express the state of the macro instruction icons 433 being used to close the operation of the multifunctional menu 43 and being selected by the user and representing “exit”. Moreover, as to the example of explaining the first switching icon 431 with FIG. 4D, after the user selects the first switching icon 431 with the human input device 20, the computer 10 immediately shuts the multifunctional menu 43 and displays in the popup auto-scroll menu 41.

A step 307 is to receive the input signals of icons selected on the menu 40 with the human input device 20; and a step 309 is to execute the commands corresponding to the input signals of the step 307. The principal object of the steps 307 and 309 are used to make the user know how to operate on the menu 40, and to make the computer 10 execute the corresponding commands. The user can select the macro instruction icons 433 and the instruction icons 435 respectively corresponding to the macro instruction icons 433 shown in FIGS. 4A-4D with the human input device 20. The user also can execute the function of scrolling with the human input device 20. Furthermore, the user can select with the human input device 20 between the first switching icon 431 and the second switching icon 411, so that he can switch between the menus 41 and 43.

A macro instruction icon 433 of the present invention mainly is used as a human interface and by way of such a human interface provided by the present invention, a functional menu with multiple layers can be put together as a single operational display frame. Thereby after the user selecting the macro instruction icon 433, at least one corresponding instruction icon 435 is displayed automatically according to the selected macro instruction icon 433 so that all the related applications of the macro instruction icon 433 can be represented by the single display frame. Hence, problem of confused display frame in the functional menu with multiple layers resided in the conventional art can be solved. Accordingly, the present invention thus can provide the user an environment of single operation with simple and tidy display frame.

The method 30 of the present invention can be realized the above steps 301 to 309 by means of codes in coding program, the program codes can be used as a driver of the human input device 20, or can be used as an application program for increasing the value of hardware of the human input device 20.

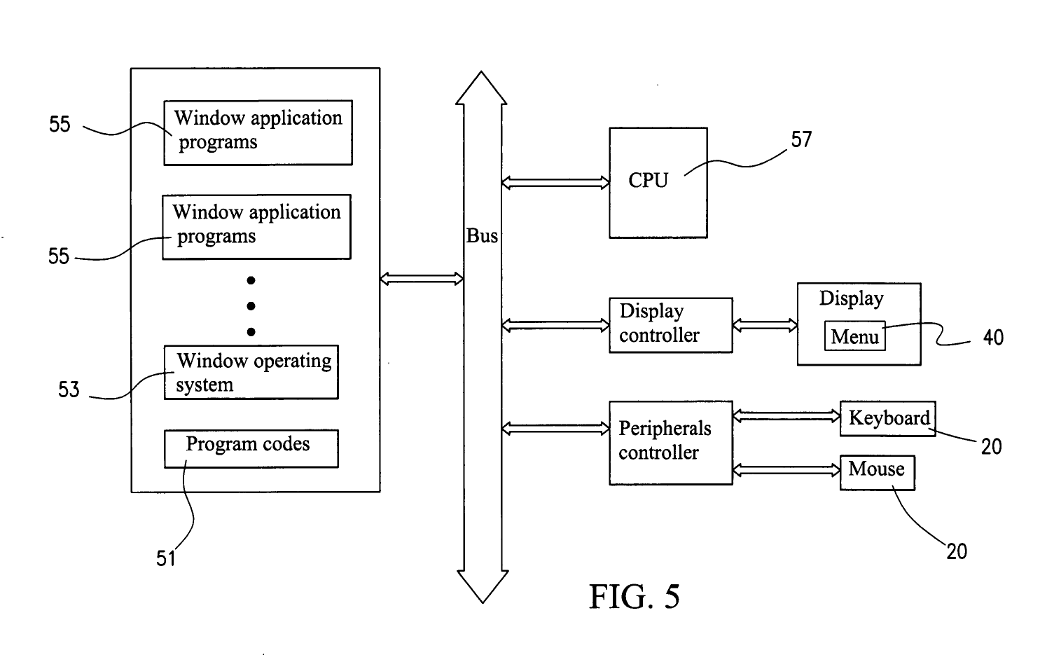

FIG. 5 shows the construction of the human input system used for embodying the method of the present invention. The human input system of the present invention is applied on a window operating system 53 having a plurality of window application programs 55 and the window application programs 55 and the window operating system 53 are executed by a CPU 57. The human input system includes the human input device 20, the menu 40 and program codes 51 used in the human input device 20. According to above description, the human input device 20 used in the method 30 of the present invention can be a cable mouse, a wireless mouse, a cable keyboard or a wireless keyboard etc. for providing the pressing signal induced by predetermined key. The menu 40 is exactly the menu described for the method 30, and no further description of its content and structure is required, it is displayed in the popup mode on the display. The program codes 51 are executed on the window operating system 53 to practically accomplish above steps 301 to 309.

The amount of the macro instruction icons 433 of the menus 43 and the corresponding instruction icons 435 is not limited to those disclosed in the drawings, those skilled in the art can make different amounts. Moreover, the macro instruction icons 433 and the corresponding instruction icons 435 are not limited to those related applications cited, those skilled in the art can change the icons for other applications according to the spirit of the present invention. And more, the application programs or the data in corresponding with the instruction icons 435 of the present invention, such as the data of the corresponding web sites to the icons in the first page of FIG. 4A, can be additionally set by the user.

The menu 40 of the present invention can be updated the content thereof, such as the instruction icons 435 of the macro instruction icons 433. Taking the macro instruction icons 433 representing related applications in the network as an example, the present invention can be designed to have an instruction icon 435 for being downloaded and updated in the network by the user such that the content of the menu 40 can keep updated at any time through the instruction icon 435. In this way, the menu 40 of the present invention can have a feature of being more flexible.

It will be apparent to those skilled in this art that various changes can be made to the present invention without departing from the spirit and conception of this invention; and all such equivalent modifications and changes shall fall within the scope of the appended claims.

1. A method to process a multifunctional menu of a human input device, said method being applied on a window operating system having a plurality of window application programs, comprising the following steps:
(A). providing a menu operated via said human input device, wherein said menu comprises: an auto-scroll menu for indicating function of scrolling, and a multifunctional menu for operating a plurality of window application programs with the human interface, wherein said multifunctional menu includes a plurality of macro instruction icons, a plurality of instruction icons corresponding to said macro instruction icons, and a first switching icon used on said multifunctional menu for switching to said auto-scroll menu, which includes a second switching icon for switching to said multifunctional menu;
(B). receiving a predetermined pressing signal of said human input device;
(C). displaying said menu in a popup mode according to said pressing signal of step (B);
(D). receiving input signals of icons selected by said human input device on said menu; and
(E). executing commands in correspondence with said input signals of step (D);
wherein, the macro instruction icons are human operating interfaces to join said multifunctional menu with multiple layers as a single display frame instead of multiple layers of display frames so as to offer a user an environment of single operation and a simple and tidy display frame.

2. The method of claim 1, wherein steps (A) to (E) are implemented by way of encoding as program codes.

3. The method of claim 1, wherein said human input device can be one of a mouse, a keyboard, a joy stick, a trackball, a touch pad and a cursor input device.

4. The method of claim 1, wherein said instruction icons are for operating said window application programs.

5. The method as defined in claim 1, wherein the instruction icons are used for operating the window operation system.

6. The method of claim 1, wherein said predetermined key is one of a middle key, a third key, a fourth key, a fifth key and a further added key of a mouse.

7. The method of claim 1, wherein said predetermined key is one key or one of a group of keys.

8. The method of claim 1, wherein said menu is one of which the content is adapted for updating.

9. A human input system applied on a window operating system having a plurality of window application programs, comprising:
a human input device, being used for executing window application programs and providing a pressing signal of a predetermined key;
a menu operated by said human input device, further comprising an auto-scroll menu for indicating function of scrolling and a multifunctional menu for operating a plurality of window application programs with human interface operation; wherein said multifunctional menu includes a plurality of macro instruction icons, a plurality of instruction icons corresponding to the macro instruction icons and a first switching icon for switching to said auto-scroll menu;
said auto-scroll menu includes a second switching icon used for switching said auto-scroll menu to said multifunctional menu; and
program codes, being used in said human input device to execute in the window operation system for accessing following procedures:
receiving said pressing signal induced by said predetermined key of said human input device;
displaying said menu in a popup mode according to said pressing signal;
receiving input signals of icons selected on said menu by said human input device; and
executing commands in correspondence with said input signals of said icons;
wherein, the macro instruction icons are human operating interfaces to join said multifunctional menu with multiple layers as a single display frame instead of multiple layers of display frames so as to offer a user an environment of single operation and a simple and tidy display frame.

10. The human input system of claim 9, wherein said human input device is one of a mouse, a keyboard, a joy stick, a trackball, a touch pad and a cursor input device.

11. The human input system of claim 9, wherein said instruction icons are for operating said window application programs.

12. The human input system of claim 9, wherein said instruction icons are for operating said window operating system.

13. The human input system of claim 9, wherein said predetermined key is one of a middle key, a third key, a fourth key, a fifth key and a further added key of said mouse.

14. The human input system of claim 9, wherein said predetermined key is one key or one of a group of keys.

15. The human input system of claim 9, wherein said menu is capable of being updated.
